(19) United States
(12) Patent Application Publication
(10) Pub. No.: US 2020/0234558 A1
(43) Pub. Date: Jul. 23, 2020

(54) MECHANICAL FAILURE DETECTION SYSTEM AND METHOD

(71) Applicants: Joseph G. Butera, III, Stuart, FL (US); Mark J. Harpster, Port St. Lucie, FL (US); Robert J. Summers, III, Port St. Lucie, FL (US); Ryan J. Copt, Port St. Lucie, FL (US)

(72) Inventors: Joseph G. Butera, III, Stuart, FL (US); Mark J. Harpster, Port St. Lucie, FL (US); Robert J. Summers, III, Port St. Lucie, FL (US); Ryan J. Copt, Port St. Lucie, FL (US)

(21) Appl. No.: 16/719,099

(22) Filed: Dec. 18, 2019

Related U.S. Application Data
(60) Provisional application No. 62/781,307, filed on Dec. 18, 2018.

(51) Int. Cl. G08B 21/18

(52) U.S. Cl. CPC G08B 21/187

(57) ABSTRACT

A mechanical failure detection system for mechanical equipment that has an acoustic capture device disposed in operative proximity to the mechanical equipment in order to acquire an operative state audio signal from the mechanical equipment, and a signal processor structured to processes the operative state audio signal and isolate a constituent signal from the operative state audio signal. The system further includes an operation processor that identifies operating parameters of the mechanical equipment that substantially correspond with the operative state audio signal an which facilitate analysis by a test processor that maintains base line audio signals and corresponding base line operational parameters so that it can compare them to the constituent signal and identify correlations between the constituent signal and the base line audio signal indicative of an operational state of the mechanical equipment such as a failure state.

### CLAIM OF PRIORITY

The present non-provisional patent application claims priority pursuant to 35 U.S.C. Section 119(e) to a currently pending, and prior-filed, provisional patent application, namely that having Ser. No. 62/781,307 filed on Dec. 18, 2018; the contents which are incorporated herein by reference.

### BACKGROUND OF THE INVENTION

### Field of the Invention

The present invention relates to a mechanical failure detection system and method which utilizes acoustic signals generated by mechanical equipment in order to identify and or predict failures or a sub-optimal operational state of the mechanical equipment via direct detection.

### DESCRIPTION OF THE RELATED ART

There are a variety of different types of mechanical equipment that are continuously used in many different types of operational environments and operating conditions. One of the most important things that must often be reviewed, monitored and/or analyzed regarding the use of that equipment relates to the detection or identification of failures and/or potential failures in all or part of the mechanical equipment. This is the case in a wide variety of different types of mechanical equipment including industrial machinery, engines, motors, pressurized containers, gears, conveyors and the like, as well as their component and related parts, all of which undergo regular usage and operation, and for which a failure can often be very costly in a variety of ways.

For this reason, extensive efforts are usually undertaken to attempt to predict when failures or malfunctions will occur or to simply identify that a malfunction or a sub optimal operational condition is present. Indeed, in many cases simply detecting that a malfunction, even though it may be slight, has occurred can be a critical factor in order to prevent substantial future damage or loss. For example, if a particular piece of mechanical equipment is operating under sub optimal operational conditions (i.e. is in a failure state), the resultant product or output can be defective or faulty requiring a recall or re-run of the process. Alternatively, even a relatively minor fault or failure state can be indicative of a much larger problem that is present or that can develop if the minor problem is not identified and quickly remedied.

Unfortunately, with many different types of mechanical equipment, easy detection of sub optimal operating conditions and or other types of mechanical failure are not easy to achieve. In fact, in many cases, rudimentary detection techniques are employed to identify those conditions, or operators/inspectors simply rely on conventional gauges and sensors that are already in place for other purposes in an attempt to indirectly guess if there has been a malfunction or a change in operative states versus simply a normal fluctuation in operating condition. Likewise, visual detection cannot usually be relied upon to detect changes in operating conditions given the crowded or dirty or inaccessible normal usage conditions of many different types of mechanical equipment, or simply the fact that visual inspection would not identify the failure.

One example of such a failure condition of mechanical equipment can relate to the use of pressurized containers. For example, a pressurized container, such as a fuel storage tank, oil storage chamber, cryogenic tanks and the like, needs to remain completely sealed in order for it to operate under optimal conditions. In fact, even if a leak is insufficient to prevent the operation of the equipment, only a slight leak can still result in the emission of unwanted toxins, can reduce the proper operation and efficiency of systems to which the container is connected, or can lead to or indicate a much larger, potentially catastrophic, failure to come.

Presently, although the observation of conventional gauges and sensors such as a pressure gauge may suggest that a failure condition is occurring, normal fluctuations and variations in operating conditions those gauges are intended to monitor often make such types of detection difficult to truly utilize. Further, not all mechanical equipment includes a variety of different sensors already attached and connected that can affectively indicate changes in operational states, such as a leak. This leaves operators of the mechanical equipment often faced with very rudimentary techniques to identify whether a failure or change of state has occurred. For example, in the case of pressurized containers soap and water are often the preferred tool used in an attempt to identify if a leak is present.

Accordingly, it would be highly beneficial to provide a mechanical failure detection system and method that is not impeded by the normal fluctuations and variations that are conventionally observed by traditional gauges and sensors, and which can be utilized in almost all operating conditions of the mechanical equipment.

It would be further beneficial to provide such a mechanical failure detection system that does not in any way impede or interfere with the normal operation of the mechanical equipment such as may be the case with sensors that necessarily measure and/or monitor the operations being performed by the mechanical equipment themselves.

Additionally, it would be beneficial to provide a mechanical failure detection system and method that is highly accurate, has the ability to be continuously refined and expanded to improve that accuracy, and is not reliant entirely upon speculative extrapolation of other data sources versus direct detection.

### SUMMARY OF THE INVENTION

The present invention is directed to a mechanical failure detection system that is configured to be utilized with a variety of different types of mechanical equipment, such as engines, bearings, gearing, pressurized tanks and the like in order to efficiently and effectively identify the presence of an optimal or sub optimal operational state of the mechanical equipment via direct detection.

The failure detection system includes at least one acoustic capture device. The acoustic capture device is structured to acquire audio signals, and in particular at least one operative state audio signal, preferably directly from the mechanical equipment. As such, the acoustic capture device is preferably disposed in operative proximity to the mechanical equipment so as to be able to effectively detect and acquire the audio signals being generated by the mechanical equipment itself.

Further, the present mechanical failure detection system includes a signal processor. The signal processor is structured to process the operative state audio signal captured by the acoustic capture device. Moreover, the signal processor will isolate at least one constituent signal from the operative state audio signal in order to facilitate its effective use and comparison.

An operation processor is also included with the mechanical failure detection system. The operation processor is structured to identify additional operating parameters of the mechanical equipment. The operation processor is optimally structured to identify those operating parameters that correspond to the operative state audio signal that has been captured or acquired by the acoustic capture device. In this way, the correspondent operating parameters can be directly correlated to the operative state audio signal in order to match them at any given time.

A test processor is also provided. The test processor is structured to maintain at least one baseline audio signal, and corresponding baseline operational parameters associated with that baseline audio signal. In this manner, the test processor is structured to compare the constituent signal that has been isolated from the operative state audio signal, with the baseline audio signal, in order to identify correlations between the constituent signal and the baseline audio signal that are indicative of an operational state of the mechanical equipment. In many cases this may include correlations indicative of a malfunction or failure, or can include correlations indicative that the mechanical equipment is operating normally such that deviations from that normal operational state would identify a mechanical failure. Moreover, the correlations identified by the test processor can also be of a predictive nature wherein changes in an operational state are identified as early warning signals which can predict, using patterns are identified in the audio signal, potential failures and/or malfunctions, prior to their actual occurrence.

An object of the present invention is to provide a system and method that does not rely on traditionally measured operational parameters for mechanical equipment in order to identify and or predict failures.

A further object of the present invention is to utilized objective data to quickly and accurately identify mechanical failures based upon direct detection.

Another object of the present invention is to utilize audio signals generated by mechanical equipment to identify and or predict mechanical failures, thereby illuminating the often imprecise or a subjective nature of other predictive methods that utilize traditional operational parameters that can often provide varied indicators and/or can often only provide limited information relative to potential mechanical failures.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a schematic representation of one embodiment of the mechanical failure detection system of the present invention;

FIG. 2 is an illustration of the mechanical failure detection system of the present invention deployed on one type of mechanical equipment.

FIG. 3 is a schematic representation of another embodiment of the mechanical failure detection system of the present invention;

FIG. 4 is a schematic representation of still another embodiment of the mechanical failure detection system of the present invention;

FIG. 5 is a flow diagram of an embodiment of the method of detecting a mechanical failure of the present invention.

Like reference numerals refer to like parts throughout the several views of the drawings.

### DETAILED DESCRIPTION OF THE PREFERRED EMBODIMENT

The present invention is directed towards a mechanical failure detection system, generally indicated as 10. The failure detection system 10 is primarily configured for use with a variety of different types of mechanical equipment 5, and uses advanced audio signal capture and analysis to provide more accurate and indicative information and alerts regarding the mechanical equipment's operational state. This can include, for example, the identification of failures and/or potential failures, or the monitoring of normal operational states such that deviations are suggestive of failures.

The type of mechanical equipment 5 with which the present mechanical failure detection system 10 can be used can vary greatly, and can include equipment such as engines, engine components, gears, bearings, housing assemblies, hinges, etc. Further, it should be understood that for the purposes of the present invention, the term failure is intended simply to identify any operation of the equipment and/or change in the operational state of the mechanical equipment 5, including its component parts, that is sub-optimal. Failure does not necessarily require a break or inoperative malfunction. Likewise, as will be reiterated subsequently, a failure can be detected either by identifying a failure operational state or by monitoring for normal or optimal operational states and simply identifying a departure or deviation from that normal or optimal operational state.

Although as indicated the present mechanical failure detection system can be used with a variety of different types of mechanical equipment 5, for the purpose of clarity and ease in explanation, the present invention will be described primarily with regard to failure detection associated with a pressurized container. Naturally, it is understood that such a pressurized container is only an example of the type of mechanical equipment 5 with which the present mechanical failure detection system 10 can be used, and is not intended to be limiting in any manner. With that consideration in mind, a significant issue that often arises with regard to pressurized containers 5 is the potential for leaks. Naturally, these leaks can be very damaging, and in some cases catastrophic if not detected soon enough. The mechanical failure detection system 10 of the present invention is configured to, in some embodiments, identify weather a failure condition exists such as by identifying the presence of a leak, or to be able to predict when the operational state of the mechanical equipment 5 is such that a failure and or change operational state is likely to occur in the relatively near future. For example, that a leak condition is imminent.

The mechanical failure detection system 10 of the presence invention includes at least one acoustic capture device 20. This acoustic capture device 20 can include a variety of formats that are structured to acquire an audio signal. For example, the acoustic capture device 20 can include one or more microphones, such as preferably a contact microphone or transducer, vibrascopes, and/or accelerometers, among other types of acoustic capture devices 20. Specifically, it is generally understood that all audio signals are effectively a collection of acoustic and vibrational data, which can sometimes be represented as waves or data points. The acoustic capture device 20 is therefore structured to acquire this data (i.e. the audio signal) so that it can be used for analysis, transmission, transformation, etc. Therefore, during normal operation, all mechanical equipment 5 will emit an operative state audio signal at some point, and usually continuously. This operative state audio signal can include the general vibrations of the surface of the mechanical equipment during normal operation, or can include the vibrations that are being generated by the mechanical equipment 5 during periods of failure and or impending failure. Utilizing further the example of a pressurized container as the mechanical equipment 5, the present invention recognizes that if a leak is present in the pressurized container, vibrations indicative of the leak are emitted, which are different than vibrations during a normal operational state, or during the period just prior to a leak, or during periods when other failure conditions such as clog or broken valve or deformed tank are present. The acoustic capture device 20 of the present invention is thereby structured to acquire and store or convey for storage and analysis the operative state audio signal.

Looking further to the acoustic capture device 20, it is understood that one or more acoustic capture devices 20 may be utilized with a particular article of mechanical equipment 5 depending upon the size of the mechanical equipment 5 and/or the degree to which one or more operative state audio signals are to be acquired to maximize effective analysis. In this regard, the acoustic capture device 20 is preferably directly attached to a surface of the mechanical equipment such that the audio signal can be acquired directly from the mechanical device with minimal to no external interference and or external vibrations affecting and or being captured as well. Naturally, however, any positioning in appropriate operative proximity to the mechanical equipment 5 is satisfactory so long as an accurate operative state audio signal can be acquired from the mechanical equipment 5 in a consistent manner. Further, the acoustic capture device is preferably configured to continuously acquire operative state audio signals, or as will be described subsequently, can by configured to acquire the audio signals only for certain periods of time or when certain operating parameters or conditions are met. For example, acquisition can occur at regular intervals, only when other, typically less accurate, sensors show a particular operational state, when manually triggered, or continuously.

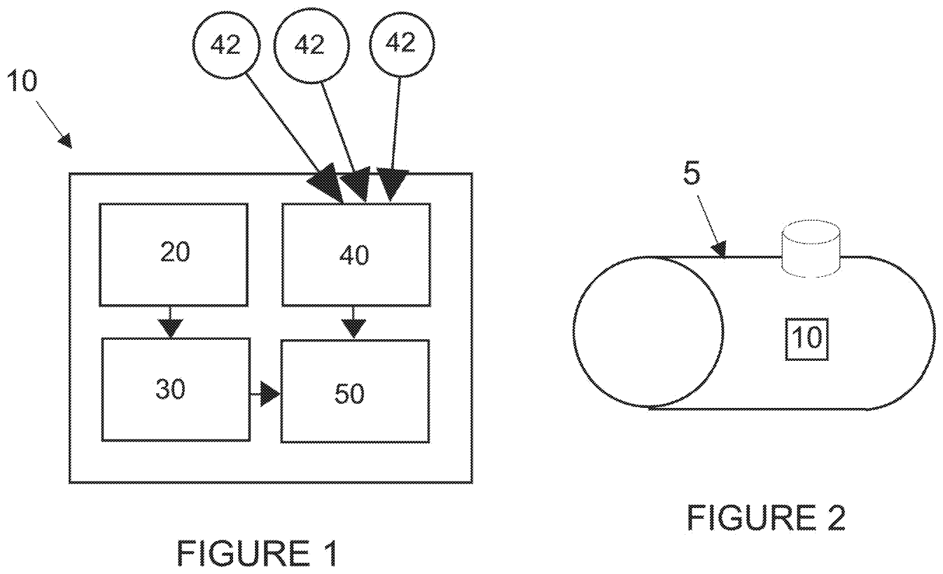

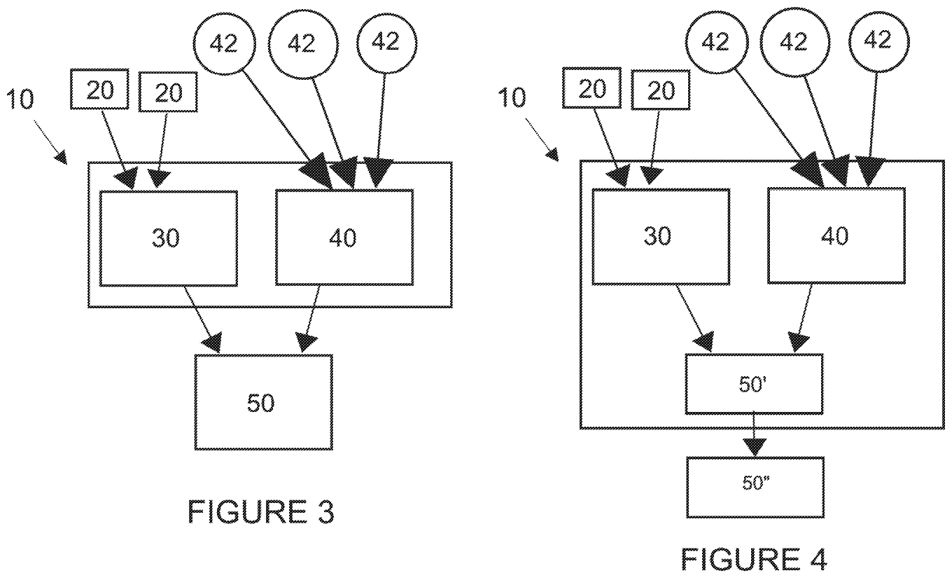

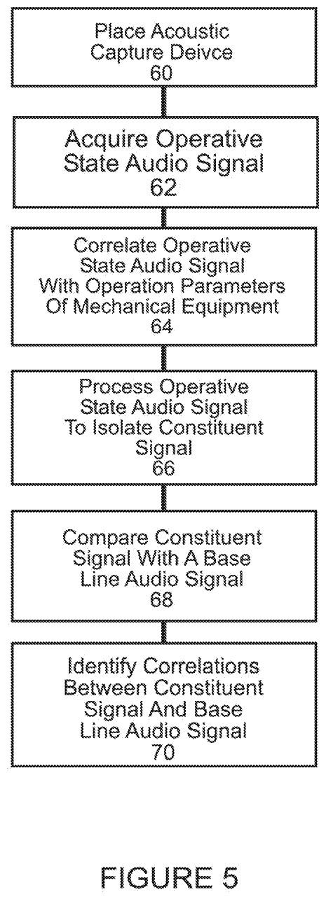

As shown in FIGS. 1 and 2, the acoustic capture device 20 can be integrally formed as part of a single mechanical failure detection system 10 module or unit that is attached to the mechanical equipment 5, or the acoustic capture device(s) 20 can be separate, as in the embodiment of FIG. 3, and be connected via wired or wireless means to a remainder of the system 10. A primary objective is that the one or more acoustic capture devices 20 be positioned in the best locations to acquire at least one and potentially more and/or continuous operative state audio signals from the mechanical equipment 5.

In addition to the one or more acoustic capture devices 20, the present mechanical failure detection system 10 also includes at least one signal processor 30. The signal processor 30 can be integrally formed or connected to the acoustic capture device 20, such as within a single housing, and/or can be a separate component operatively connected to the acoustic capture device 20 and structured to process the operative audio signal(s) that has/have been acquired by the acoustic capture device 20. In general, because of the nature of a normal operating environment and/or conditions for mechanical equipment 5, the operative state audio signal will include a large amount of acoustic and/or vibrational data, such as may be represented by a plurality of different overlapping wave forms that together make the captured operative audio signal. The present invention recognizes, however, that in order to provide the most optimal and accurate results, and to be able to make truly meaningful determinations, it is best to focus the analysis of the audio signal on very specific data points, wave forms or component elements of the acquired audio signal. As such, the signal processor 30 is structured to process the operative state audio signal and to isolate at least one and possibly multiple, constituent signal(s) from the operative state audio signal. The constituent signal can include a single wave form or certain isolated data points or data sets, as may be optimal to provide the most critical and useful data to be utilized by the mechanical failure detection system 10 to achieve maximum accuracy.

Accordingly, the signal in this regard, it is understood that the signal processor 30 can include a variety of configurations and can utilize a variety of processing techniques and mechanisms. One such example can be found in U.S. Pat. No. 9,348,904 and 9.397,629 for a System and Method for Digital Signal Processing, the contents of which are hereby incorporated by reference. Likewise, the signal processor 30 can include one or more dynamic range controllers that will limit, set or otherwise regulate the range of frequencies that are acquired or that are to be analyzed or conveyed. Alternatively, filters, such as high pass or low pass filters or precise range filters that expressly filter out waveforms and/or data sets that are not within a designated frequency range, can be used. In still another embodiment an FFT (Fast Fourier Transform) Analysis of the data and/or wave forms that comprise the operative state audio signal can be conducted in order to section the resultant datasets or tensors into the at least one operative state audio signal. Of course, these are just examples of optimal signal processors 30 that may be used, and it is also understood that multiple different types of signal processors and/or processing techniques can be employed simultaneously or sequentially or independently, as may be needed to provide the most accurate and useable constituent signal.

The mechanical failure detection system 10 also includes an operation processor 40 structured to identify operational parameters of the mechanical equipment 5. The operation processor 40 is connected, either wired or wirelessly to one or more preferably existing sensors that are already associated with or connected to the mechanical equipment 5. Specifically, it is customary for mechanical equipment 5 to include a variety of sensors 42 such as temperature sensors, RPM sensors, pressure gauges and the like which measure and report on the general operational state of the mechanical equipment 5 and its operating parameters. Of course, it is understood that if the mechanical equipment 5 does not already include a variety of sensors 42 and/or the sensors that are optimal for meaningful use with the present system, the mechanical failure detection system 10 of the present invention can also include sensors 42 to identify other operating parameters of the mechanical equipment. Likewise, it is understood that the operational parameters can include factors such as clock or data capture time or date, acoustic capture device placement location or parameters, ambient temperature, the type, model number or service time of the mechanical equipment, GPS or location data, etc., which can be collected from either independent sensors or directly be operation processor 40.

The operation processor 40 is structured to identify those operating parameters that correspond the operative state audio signal that has been acquired by the acoustic capture device 20. In this manner, for any given part of the operative state audio signal, or the constituent signal(s) therefrom, that is/are analyzed, the correspondent operating parameters of the mechanical equipment 5 will be known and cross-referenced. By way of example with reference to a pressurized container as the mechanical equipment 5, the operating parameters may include temperature, the time when the operative state audio signal is being acquired, the fill level of the container and/or a readout of the pressure gauge, among other parameters. Further, it should be recognized that the operation processor 40 can be integral with one or more of the other components of the present system, can be include within a single housing or device, or can be a separate physical component that identifies the operating parameters and conveys them for proper correlation to the acquired operative state audio signal.

The mechanical failure detection system 10 of the present invention further includes a test processor generally indicated as 50. The test processor 50 is structured to maintain at least one baseline audio signal and the corresponding baseline operational parameters that correspond to the baseline audio signal. In this regard it is understood that maintaining these items may include storing them on local storage, the test processor 50 itself or on remote storage that is accessible via wired or wireless means.

By maintaining the baseline audio signal and the corresponding baseline operational parameters, the test processor 50 is thereby able to compare the one or more constituent signal(s) that have been isolated by the signal processor 30 with the baseline audio signal, and in most cases preferably a corresponding signal component of the baseline audio signal which may itself have previously or concurrently been isolated. Moreover, the operating parameters of the baseline audio signal should match the operating parameters of the operative state audio signal as that will provide the most accurate comparison and will eliminate or at least minimize differences and or mis-matches between the audio signals that result from extraneous operating conditions that are not the primary subject of the analysis. Indeed, at a minimum the operating parameters that relate to the type of mechanical equipment being analyzed is generally required.

In doing the comparison, the test processor 50 will often extract and classify particular datasets and components of the processed and isolated constituent signals for appropriate comparison. In this regard, in a preferred embodiment the test processor 50 may create an ensemble model utilizing a plurality of data points at different parts of the constituent signal thereby enhancing the comparison ability beyond a single point to point comparison. These data sets and or tensors can then be compared to similar datasets and or models formed from the baseline audio signal using a variety of analytical techniques, including what is sometimes referred to as “sliding window” analysis where a generally continuous monitoring of a continuously or semi-continuously acquired operative state audio signal is conducted in comparison to the baseline audio signal or an optimal or most indicative data set thereof.

Looking further to the test processor 50 it is understood that the classification of the constituent signal and the comparison can be achieved utilizing a variety of different data analysis techniques including the use of shallow classifiers, such as support vector machine, artificial neural network, K nearest neighbor, etc. These classifiers can then be used to transform the output into a usable data set using techniques such as time average smoothing or fuzzy threshold, the end result being the effective comparison of discrete and useful data points from the operative state audio signal, and in particular at least one constituent signal therefrom with matching data points in a baseline audio signal.

From the preceding it can be seen that the test processor 50 can include a variety of configurations. For example, it is understood that the test processor 50 and the signal processor 30 and/or other components of the present invention, may be integral and/or the same component that has multiple functions, with many of the processing steps also being part of the comparison and analysis steps. Likewise, the test processor 50 may be integral within a single housing or unit as in the embodiment of FIG. 1, or can be completely external and even possibly remote, connected by wired or wireless means to a remainder of the mechanical failure detection system 10, as in FIG. 3. Furthermore, in some embodiments, such as disclosed in FIG. 4, the test processor 50 may include multiple components, such as a first phase test processor 50′ and a second phase test processor 50″ with all or part of each either integral with and/or separate from a remainder of the mechanical failure detection system 10. In such a multipart embodiment, the test processor 50′ can be tasked with initial comparison in order to determine whether there is a reasonable probability that a change in operative parameters and or the operating condition that is being looked for exists, with the corresponding data being subsequently communicated to the second phase test processor 50″ for more significant and intensive analysis.

Additionally, it is understood that the data captured and processed by the mechanical failure detection system 10 is also preferably maintained and or stored in order to optimize future functionality of the mechanical failure detection system 10. Specifically, this maintenance or storage of captured and processed data can be achieved by the test process or 50 and/or can be offloaded via physical or wireless means to a central server and or a second phase test processor 50″ where more complex analysis, isolation and machine learning can be used to optimize the ability to detect and or predict changes in an operational state of the mechanical equipment that are indicative of the conditions that are being looked for. For example, it is contemplated that the operative state audio signal will be continuously captured during normal operation of the mechanical equipment 5 or at regular testing intervals. Regardless, however, of how often the operative state audio signal is acquired, or how much signal data is acquired, the data that is collected and processed can be very beneficial even when it is being acquired during normal or non-failure conditions. Specifically, the more data that can be acquired the greater the system 10 is able to identify anomalous situations or different types of failure situations in order to more rapidly and accurately detect audio signal data that is associated with a failure or sub optimal condition. Moreover, it is understood that all articles of mechanical equipment 5 are not the same, even if they are the same general type of equipment, and the more data that is gathered, analyzed and/or otherwise maintained as the baseline audio signal and corresponding operational parameters, the more accurate the detection and predictive capabilities of the present mechanical failure detection system 10 will be relative to other similar articles of mechanical equipment 5. In this regard, in yet another embodiment, it is also recognized that the operation processor 40 may be configured to trigger the acquisition of the operative state audio signal. For example, the operational parameters may be set to a certain time of day, when certain conditions exist that are themselves indicative of a potential failure but validation is desired, or when certain conditions that have not previously been monitored but it would be good to add to the baseline audio signal data set or to ensure that a new or anomalous failure condition is not present, arise, in order to trigger the acquisition of the operative state audio signal for use in analysis, to identify a failure and/or to better reinforce and/or enhance and/or add to the baseline audio signal.

It is also understood that the mechanical failure detection system 10 of the present invention can also include an alert or warning signal. This can include an alert or warning light or sound emitter or alarm directly attached to the mechanical equipment 5, or remotely located and triggered via wired or wireless means so that the appropriate personnel can be made aware of a failure or imminent failure condition, or so that automated processes can take place such as a shutdown or throttling of the mechanical equipment 5. Naturally, normal data transmission of the analysis conducted or the raw data can also be communicated to a remote server or source to provide additional and/or secondary review and/or monitoring.

From the preceding it is also seen that a method of detecting failures in mechanical equipment has been described. To re-iterate, the method preferably includes a number of steps that can begin with the placing of at least one acoustic capture device on mechanical equipment to be monitored or analyzed. Thereafter, as needed or as triggered by an operator or the presence of certain operating parameters, an operative audio signal that is being generated by the mechanical equipment 5 is acquired directly from the mechanical equipment. This operative audio signal is correlated with other operational parameters of the mechanical equipment, and is processed so as to isolate at least one constituent signal. The constituent signal is then compared with a previously acquired and preferably processed base line audio signal having corresponding operational parameters to those that align with the operational parameters of the mechanical equipment that correspond to the constituent signal. Finally, correlations between the base line audio signal and the constituent signal that are indicative of mechanical failure in the mechanical equipment can be identified and if desired, appropriate alerts and/or alarms can be triggered.

Since many modifications, variations and changes in detail can be made to the described embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A mechanical failure detection system for mechanical equipment, said mechanical failure detection system comprising:
at least one acoustic capture device disposed in operative proximity to the mechanical equipment and structured to acquire at least one operative state audio signal from the mechanical equipment;
a signal processor structured to processes said operative state audio signal and to isolate at least one constituent signal from said operative state audio signal;
an operation processor structured to identify correspondent operating parameters of the mechanical equipment that substantially correspond with said operative state audio signal;
a test processor structured to maintain at least one base line audio signal and corresponding base line operational parameters; and
said test processor further structured to compare said at least one constituent signal that corresponds to said correspondent operative parameters, with said base line audio signal, and to identify correlations between said constituent signal and said base line audio signal indicative of an operational state of the mechanical equipment.

2. The mechanical failure detection system recited in claim 1 wherein said base line audio signal is indicative of a sub-optimal state of the mechanical equipment and said test processor is structured to identify a match between said constituent signal and said base line audio signal.

3. The mechanical failure detection system recited in claim 1 wherein said base line audio signal is indicative of an optimal state of the mechanical equipment and said test processor is structured to identify a mis-match between said constituent signal and said base line audio signal.

4. The mechanical failure detection system recited in claim 1 wherein said acoustic capture device comprises a contact microphone structured to be mounted in operative proximity to a surface of the mechanical equipment and to acquire said operative state audio signal from the surface of the mechanical equipment, thereby minimizing ambient acoustic interference.

5. The mechanical failure detection system recited in claim 1 wherein said acoustic capture device comprises a vibrascope structured to be mounted in operative proximity to a surface of the mechanical equipment and to acquire said operative state audio signal based upon a vibration of the mechanical equipment.

6. The mechanical failure detection system recited in claim 1 wherein said acoustic capture device comprises an accelerometer structured to be mounted in operative proximity to the mechanical equipment and to acquire said operative state audio signal based upon dynamic acceleration forces exhibited by the mechanical equipment.

7. The mechanical failure detection system recited in claim 1 wherein said signal processor comprises a dynamic range controller structured to normalize said operative state audio signal to isolate said at least one constituent signal.

8. The mechanical failure detection system recited in claim 1 wherein said dynamic range controller isolates a plurality of constituent signals, said test processor comparing said one constituent signal that corresponds to said operational state of the mechanical equipment for which mechanical failure information is desired.

9. The mechanical failure detection system recited in claim 1 wherein said signal processor comprises a pass through filter structured to allow passage of only predetermined frequency ranges of said operative state audio signal in order isolate said at least one constituent signal in said predetermined frequency range.

10. The mechanical failure detection system recited in claim 1 wherein said signal processor is structured to perform an FFT analysis of said operative state audio signal in order to section said operative state audio signal into at least said one constituent signal that corresponds to said operational state of the mechanical equipment for which mechanical failure information is desired.

11. The mechanical failure detection system recited in claim 1 wherein said at least one acoustic capture device is structured to acquire a plurality of said operative state audio signals over a predetermined time period.

12. The mechanical failure detection system recited in claim 1 wherein said test processor is structured to isolate a plurality of data points at different parts of said constituent signal and generate an ensemble model of said data points from said different parts so as to improve an accuracy of correlations identified.

13. The mechanical failure detection system recited in claim 12 wherein said test processor is structured to conduct a sliding window analysis of said ensemble model in comparison to corresponding data points of said base line audio signal in order to identify correlations to said baseline audio signal indicative of a malfunction of the mechanical equipment.

14. The mechanical failure detection system recited in claim 1 wherein said test processor includes a first phase test processor and a second phase test processor, said first phase test processor disposed in operative proximity to the mechanical equipment and structured to conduct an initial comparison, and said second phase test processor structured to conduct a secondary comparison if said initial comparison is indicative of a malfunction of the mechanical equipment.

15. The mechanical failure detection system recited in claim 1 wherein said signal processor is wirelessly connected to said acoustic capture device.

16. The mechanical failure detection system recited in claim 1 wherein said test processor is structured to maintain said operative state audio signal and said corresponding operating parameters acquired during normal operation of the mechanical equipment in order to improve upon a determinative accuracy of said baseline audio signal.

17. The mechanical failure detection system recited in claim 1 wherein said test processor maintains said baseline audio signal by storing it on accessible remote storage.

18. The mechanical failure detection system recited in claim 1 wherein said test processor is disposed remote from the mechanical equipment.

19. The mechanical failure detection system recited in claim 1 wherein said operation processor is structured to independently identify malfunctions of the mechanical equipment utilizing conventional means, and to initiate a tagging of said operative state audio signal that corresponds to a malfunction, said test processor structured to utilize said tagged operative state audio signal to refine said baseline audio signal that is indicative of a malfunction.

20. A method of detecting failures in mechanical equipment comprising the steps of:
a) Acquiring an operative audio signal being generated by the mechanical equipment directly from the mechanical equipment;
b) Correlating said operative audio signal with other operational parameters of the mechanical equipment;
c) Processing the operative audio signal to isolate at least one constituent signal;
d) Comparing the constituent signal with a base line audio signal having corresponding operational parameters to those that align with the operational parameters of the mechanical equipment that correspond to the constituent signal; and
e) Identifying correlations between said base line audio signal and said constituent signal that are indicative of mechanical failure in the mechanical equipment.
